(19) United States
(12) Patent Application Publication
(10) Pub. No.: US 2013/0149549 A1
(43) Pub. Date: Jun. 13, 2013

(54) METALLIC STRUCTURES BY METALLOTHERMAL REDUCTION

(71) Applicants: Nicholas Francis Borrelli, Elmira, NY (US); Shawn Michael O'Malley, Horseheads, NY (US); Vitor Marino Schneider, Painted Post, NY (US)

(72) Inventors: Nicholas Francis Borrelli, Elmira, NY (US); Shawn Michael O'Malley, Horseheads, NY (US); Vitor Marino Schneider, Painted Post, NY (US)

(21) Appl. No.: 13/693,453

(22) Filed: Dec. 4, 2012

Related U.S. Application Data
(60) Provisional application No. 61/569,457, filed on Dec. 12, 2011.

(51) Int. Cl. C01B 33/023; C01B 33/02

(52) U.S. Cl. CPC C01B 33/023; C01B 33/02; Y10S 977/762; Y10S 977/896; B82Y 40/00
USPC 428/613; 423/348; 423/350; 977/762; 977/896

(57) ABSTRACT

Compositions made by metallothermal reduction from aerogels and phase separated glasses and glass ceramics formed and methods of producing such compositions are provided. The compositions have novel structures that incorporate nanoporous silicon and other metal, metalloid, or metal-oxide nanowires in form of three-dimensional scaffolds. Additional compositions possess unusual photoluminescence properties that indicate possible applications in lighting and electronics.

This application claims the benefit of priority under 35 USC §119 of U.S. Provisional Application Ser. No. 61/569,457 filed Dec. 12, 2011 the content of which is relied upon and incorporated herein by reference in its entirety.

### FIELD

Embodiments generally relate to compositions formed by metallothermal reduction and methods of producing such compositions. More particularly, embodiments relate to single-element amorphous compositions formed by metallothermal processes that have novel structures, and methods of producing such compositions.

### BACKGROUND

There is a growing interest in controlling the shape and properties of materials at sizes on the nano- and microscale. Materials with features on this scale have potential uses in a large number of areas, such as in electronics, fuel cells, pH- and other types of sensors, catalysts, and biotechnology. However, the continuing challenge in developing such materials is how to efficiently and effectively produce them.

### SUMMARY

Embodiments are directed to forming novel products utilizing metallothermic processes on two- and three-dimensional structures comprising both single and multiple elements and methods of forming such products.

Herein are described metallothermic processes to create nanoporous silicon and other metal, metalloid, or metal-oxide nanowires in form of a three-dimensional scaffold. In some embodiments, the process comprises utilizing metallothermic processes in an aerogel that has initial oxide nanowires of the order of a few nanometers. The resulting materials possess unusual photoluminescence properties that indicate possible application of processes and materials produced in lighting, electronic, light and thermal insulation at unusual wavelengths, among other applications. The processes described herein may also be applied to phase separated glasses and glass ceramics to form highly porous materials and structures and allow for formation of extruded and molded devices that have the additional benefit of being more mechanically stable than presently available aero gels.

A first embodiment comprises a composition comprising an aerometal. In some embodiments, the aerometal has a density of from about 1 mg/cm³ to about 500 mg/cm³. In some embodiments, the aerometal has a surface area of from about 200 to about 2000 m²/g. In some embodiments, the aerometal has an average pore size of from about 0.4 to 1000 nm. In some embodiments, the aerometal is photoluminescent or electroluminescent. In some embodiments, the aerometal comprises nanowires. In some embodiments, the aerometal comprises a powder. In some embodiments, the aerometal comprises a film. In some embodiments, the aerometal comprises a body.

Another embodiment comprises a method of producing an aerometal, comprising forming an aerogel of a metal oxide or metallaloid oxide; subjecting the aerogel to a metallothermic process; and optionally, removing reaction by-products to give a substantially pure aerometal. In some embodiments, the subjecting the aerogel to a metallothermic process step comprises heating to a temperature of greater than 400° C. for more than 2 hours. In some embodiments, the subjecting the aerogel to a metallothermic process step comprises heating to a temperature of greater than 400° C. for more than 2 hours and subsequently, heating to a temperature of greater than 600° C. for more than 2 hours. In some embodiments, the removing reaction by-products comprises acid etching the aerometal. In some embodiments, the aerometal produced has a density of from about 1 mg/cm³ to about 500 mg/cm³. In some embodiments, the aerometal produced has an average pore size of from about 0.4 to 1000 nm. In some embodiments, the aerometal produced is photoluminescent or electroluminescent. In some embodiments, the aerometal produced comprises nanowires. In some embodiments, the aerometal produced comprises a powder. In some embodiments, the aerometal produced comprises a film. In some embodiments, the aerometal produced comprises a body.

Another embodiment comprises a method of forming an aerometal comprising: providing an aerogel comprising a metal oxide or metalloid oxide; extracting oxygen from the aerogel by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield a nanostructured substrate with a density of less than 200 mg/cm³.

Another embodiment comprises a composition comprising elemental nanowires wherein the composition has a density from about 1 mg/cm³ to about 500 mg/cm³ and the elemental nanowires comprise a metal or metalloid. In some embodiments, the composition comprises an aerometal. In some embodiments, the composition has a surface area of from about 200 to about 2000 m²/g. In some embodiments, the composition has an average pore size of from about 0.4 to 1000 nm. In some embodiments, the composition is photoluminescent or electroluminescent. In some embodiments, the aerometal comprises a film.

Another embodiment comprises body comprising elemental nanowires wherein the body has a density from about 1 mg/cm³ to about 500 mg/cm³ and the elemental nanowires comprise a metal or metalloid. In some embodiments, the body comprises an aerometal. In some embodiments, the body has a surface area of from about 200 to about 2000 m²/g. In some embodiments, the body has an average pore size of from about 0.4 to 1000 nm. In some embodiments, the body is photoluminescent or electroluminescent.

Another embodiment comprises a powder comprising elemental nanowires wherein the powder has a density from about 1 mg/cm³ to about 500 mg/cm³ and the elemental nanowires comprise a metal or metalloid. In some embodiments, the powder comprises an aerometal. In some embodiments, the powder has a surface area of from about 200 to about 2000 m²/g. In some embodiments, the powder has an average pore size of from about 0.4 to 1000 nm. In some embodiments, the powder is photoluminescent or electroluminescent.

Another embodiment comprises nanowires formed by process comprising: forming an aerogel of a metal oxide or metallaloid oxide; subjecting the aerogel to a metallothermic process to form metal or metalloid nanowires; optionally, removing reaction by-products to give substantially pure nanowires; and optionally, isolating the substantially pure nanowires. In some embodiments, the subjecting the aerogel to a metallothermic process comprises heating to a temperature of greater than 400° C. for more than 2 hours. In some embodiments, the subjecting the aerogel to a metallothermic process comprises heating to a temperature of greater than 400° C. for more than 2 hours and subsequently, heating to a temperature of greater than 600° C. for more than 2 hours. In some embodiments, the nanowires comprise a powder. In some embodiments, the nanowires comprise a film. In some embodiments, the nanowires comprise a body. In some embodiments, the removing reaction by-products comprises acid etching the nanowires.

Another embodiment comprises a method of producing nanowires comprising: forming an aerogel of a metal oxide or metallaloid oxide; subjecting the aerogel to a metallothermic process to form metal or metalloid nanowires; optionally, removing reaction by-products to give a substantially pure nanowires; and optionally, isolating the substantially pure nanowires. In some embodiments, the subjecting the aerogel to a metallothermic process comprises heating to a temperature of greater than 400° C. for more than 2 hours. In some embodiments, the subjecting the aerogel to a metallothermic process comprises heating to a temperature of greater than 400° C. for more than 2 hours and subsequently, heating to a temperature of greater than 600° C. for more than 2 hours. In some embodiments, the removing reaction by-products comprises acid etching the nanowires. In some embodiments, the nanowires comprises a powder. In some embodiments, the nanowires comprise a film. In some embodiments, the nanowires comprise a body.

Another embodiment comprises a method of forming a nanowire comprising: providing an aerogel comprising a metal oxide or metalloid oxide; extracting oxygen from the aerogel by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield a nanostructured substrate with a density of less than 200 mg/cm³.

Another embodiment comprises a body comprising a cellular structure wherein the body comprises a metal or metalloid in elemental form; wherein the cellular structure comprises interconnected pores with an average pore size of from about 0.4 to 1000 nm. In some embodiments, the surface area of the body is from about 200 to 2000 m²/g. In some embodiments, the body is photoluminescent or electroluminescent. In some embodiments, the body is photoluminescent below 400 nm. In some embodiments, the body is formed from a phase separated glass or glass ceramic. In some embodiments, the phase separated glass or glass ceramic comprises a borosilicate glass.

Some embodiments comprise an article comprising a body comprising a cellular structure wherein the body comprises a metal or metalloid in elemental form; wherein the cellular structure comprises interconnected pores with an average pore size of from about 0.4 to 1000 nm.

Another embodiment comprises a film comprising a cellular structure wherein the film comprises a metal or metalloid in elemental form; wherein the cellular structure comprises interconnected pores with an average pore size of from about 0.4 to 1000 nm. In some embodiments, the surface area of the film is from about 200 to 2000 m²/g. In some embodiments, the film is photoluminescent or electroluminescent. In some embodiments, the film is photoluminescent below 400 nm. In some embodiments, the film is formed from a phase separated glass or glass ceramic. In some embodiments, the phase separated glass or glass ceramic comprises a borosilicate glass.

Some embodiments comprise an article comprising a film comprising a cellular structure wherein the film comprises a metal or metalloid in elemental form; wherein the cellular structure comprises interconnected pores with an average pore size of from about 0.4 to 1000 nm.

Another embodiment comprises a powder comprising a cellular structure wherein the powder comprises a metal or metalloid in elemental form; wherein the cellular structure comprises interconnected pores with an average pore size of from about 0.4 to 1000 nm. In some embodiments, the surface area of the powder is from about 200 to 2000 m²/g. In some embodiments, the powder is photoluminescent or electroluminescent. In some embodiments, the powder is photoluminescent below 400 nm. In some embodiments, the powder is formed from a phase separated glass or glass ceramic. In some embodiments, the phase separated glass or glass ceramic comprises a borosilicate glass.

Some embodiments comprise an article comprising a powder comprising a cellular structure wherein the powder comprises a metal or metalloid in elemental form; wherein the cellular structure comprises interconnected pores with an average pore size of from about 0.4 to 1000 nm.

Another embodiment comprises a method of forming a body comprising a cellular structure wherein the body comprises a metal or metalloid in elemental form; wherein the cellular structure comprises interconnected pores with an average pore size of from about 0.4 to 1000 nm comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body. In some embodiments, the surface area of the body is from about 200 to 2000 m²/g. In some embodiments, the body is photoluminescent or electroluminescent. In some embodiments, the body is photoluminescent below 400 nm.

Another embodiment comprises the body comprising a cellular structure wherein the powder comprises a metal or metalloid in elemental form; wherein the cellular structure comprises interconnected pores with an average pore size of from about 0.4 to 1000 nm formed by the method comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body.

Another embodiment comprises a method of forming a film comprising a cellular structure wherein the film comprises a metal or metalloid in elemental form; wherein the cellular structure comprises interconnected pores with an average pore size of from about 0.4 to 1000 nm comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body. In some embodiments, the surface area of the film is from about 200 to 2000 m²/g. In some embodiments, the film is photoluminescent or electroluminescent. In some embodiments, the film is photoluminescent below 400 nm.

Another embodiment comprises the film comprising a cellular structure wherein the powder comprises a metal or metalloid in elemental form; wherein the cellular structure comprises interconnected pores with an average pore size of from about 0.4 to 1000 nm formed by the method comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body.

Another embodiment comprises a method of forming a powder comprising a cellular structure wherein the powder comprises a metal or metalloid in elemental form; wherein the cellular structure comprises interconnected pores with an average pore size of from about 0.4 to 1000 nm comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body. In some embodiments, the surface area of the powder is from about 200 to 2000 m²/g. In some embodiments, the powder is photoluminescent or electroluminescent. In some embodiments, the powder is photoluminescent below 400 nm.

Another embodiment comprises the powder comprising a cellular structure wherein the powder comprises a metal or metalloid in elemental form; wherein the cellular structure comprises interconnected pores with an average pore size of from about 0.4 to 1000 nm formed by the method comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the body.

Another embodiment comprises a method of forming the film comprising a cellular structure wherein the film comprises a metal or metalloid in elemental form; wherein the cellular structure comprises interconnected pores with an average pore size of from about 0.4 to 1000 nm comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the film. In some embodiments, the surface area of the film is from about 200 to 2000 m²/g. In some embodiments, the film is photoluminescent or electroluminescent. In some embodiments, the film is photoluminescent below 400 nm. Some embodiments comprise the film formed by this process.

Another embodiment comprises a method of forming the powder comprising a cellular structure wherein the powder comprises a metal or metalloid in elemental form; wherein the cellular structure comprises interconnected pores with an average pore size of from about 0.4 to 1000 nm comprising: providing a phase separated glass or glass ceramic article; extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and removing the metal-oxygen complex to yield the powder. In some embodiments, the surface area of the powder is from about 200 to 2000 m²/g. In some embodiments, the powder is photoluminescent or electroluminescent. In some embodiments, the powder is photoluminescent below 400 nm. Some embodiments comprise the powder formed by this process.

### BRIEF DESCRIPTION OF THE DRAWINGS

FIG. 1 is an XRD spectra of: a) a silica aerogel showing its amorphous background and lack of crystallinity peaks (spectrum “A”); b) aerosilicon after processing at 660° C. for 4 hours and 725° C. for 6 hours (spectrum “B”); and c) collapse of the aerogel after processing at 660° C. for 4 hours, 725° C. for 6 hours, and an acid etch in HCl:EtOH:H₂O solution due to the surface tension with the liquid (spectrum “C”). In b) one can observe the appearance of peaks for MgO (peak “x”) and Si (peaks “y”) as consistent with this stage of the processing of the sample.

FIGS. 2A and 2B show details of TEM characterizations of an aerosilicon sample at different scales after processing at 660° C. for 4 hours and 725° C. for 6 hours. The images show nanowires that are a mixture of MgO, Si and SiO₂.

FIGS. 3A and 3B show a silica aerogel (object “A”) and an aerosilicon sample (objects “B”) under ambient light (FIG. 3A) and 365 nm UV radiation (FIG. 3B). As can be seen in FIG. 3B, the aerosilicon sample (objects “B”) shows high luminescence under the UV light that is not observed in the silica aerogel.

FIGS. 4A and 4B show excitation spectra for a reference sample of quinine sulfate at 1 μM concentration (FIG. 4A) with a target emission at 447.5 nm and solid aerosilicon (FIG. 4B) after after processing at 660° C. for 4 hours and 725° C. for 6 hours with a targeted emission at 440 nm.

FIG. 5 is a comparison of quinine sulfate (10 μM in H₂SO₄) (spectrum “QS”) and solid aerosilicon (spectrum “SSA”) emission spectra as measured by fluorimeter. The parameters used were excitation at 349 nm with 0.5 nm step size and 1 μm slits used in both the source and the detector.

FIG. 6 is a comparison of quinine sulfate (1 μM in H₂SO₄) (spectrum “QS”) and solid aerosilicon (spectrum “SSA”) emission spectra as measured by fluorimeter. The parameters used were excitation at 380 nm with 0.5 nm step size and 1 μm slits used in both the source and the detector.

FIG. 7 shows emission spectra of aerosilicon (spectrum “SSA”) and aeroaluminum (spectrum “AA”). The parameters for the aerosilicon sample were excitation at 349 nm with 0.5 nm step size and 1 μm slits used in both the source and the detector. The parameters for the aeroaluminum sample were excitation at 349 nm with 1 nm step size and 2 μm slits used in both the source and the detector.

FIG. 8 is a contour graph of the emission lifetimes as a function of wavelength of the aerosilicon when excited at 349 nm. The lifetimes were measured from 380 nm to 600 nm via a photomultiplier tube. An untreated silica aerogel was used as reference sample and its spectra due to scattering of light or possible impurity defects subtracted. The graph shows changes in the peak time and changes in decay rate based on the wavelength of emission.

FIGS. 9A, 9B, and 9C are photographs of the optical emission of a porous Vycor® slab and from an extruded porous Vycor® 3D monolith both before and after methalothermic processing to form the silicon equivalent. The samples were processed at 660° C. for 4 hours, 725° C. for 6 hours, and then an acid etch in HCl:EtOH:H₂O solution. Under ambient light, the unprocessed and processed samples look similar (FIG. 9A), but when exposed to UV radiation, the processed sample was strongly luminescent in the UV at 365 nm (strong intensity) and 302 nm (medium intensity) (FIG. 9B). FIG. 9C compares the luminescence in the presence of a UV filter of the treated and untreated Vycor® samples. As can be seen from the figure, the processed Vycor® sample (sample on right) shows strong luminescence in the UV region.

FIG. 10 is an X-ray diffraction spectrum of the extruded porous Vycor® in the form of a 3D monolith of silicon. It shows just the peaks related to silicon.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this description is not limited to the specific compositions, articles, devices, and methods disclosed unless otherwise specified, as such can, of course, vary. It is also to be understood that the terminology used herein is for the purpose of describing particular aspects only and is not intended to be limiting.

The following description is provided as an enabling teaching. To this end, those skilled in the relevant art will recognize and appreciate that many changes can be made to the various aspects described herein, while still obtaining the beneficial results. It will also be apparent that some of the desired benefits can be obtained by selecting some of the features without utilizing other features. Accordingly, those who work in the art will recognize that many modifications and adaptations to the present embodiments are possible and can even be desirable in certain circumstances. Thus, the following description is provided as illustrative and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

In this specification and in the claims which follow, reference will be made to a number of terms which shall be defined to have the following meanings:

“Include,” “includes,” or like terms means encompassing but not limited to, that is, inclusive and not exclusive.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

“Aerogels,” as used herein, refers to a low density material that has been derived from a gel through extraction of the liquid components. In some embodiments, aerogel comprises at least one component comprising an oxide. In some embodiments, aerogel comprises a metal oxide. In some embodiments, aerogel may comprise elements including silica, carbon, alumina, sulfur, selenium, iron, cobalt, nickel, zinc, lanthanide, copper, cadmium, and nickel or combinations thereof. In some embodiments, aerogels may have densities from about 500 mg/cm³ to 0.5 mg/cm³. The pore size in the aerogels may be from less than about 2 nm (“microporous”), from about 2 nm to 50 nm (“mesoporous”), or greater than about 50 nm (“macroporous”), or combination thereof. In some embodiments, aerogels may be hydrophilic or hydrophobic.

“Metallothermic,” as used herein, refers to a gas/solid displacement reaction wherein at least one solid oxide compound is at least partially converted to the base element or an alternative compound comprising the base element via reaction with a gas. In some embodiments, the gas comprises Mg or Ca.

“Aerometal” or “aero[element],”as used herein, refers to an aerogel that has undergone metallothermic processing and at least part of one oxide component has been converted to the base element. For example, “aerosilicon” comprises a metallothermically processed silica aerogel wherein the silica has been at least partially converted to silicon. “Aeroaluminum” comprises a metallothermically processed alumina aerogel wherein the alumina has been at least partially converted to aluminum.

“Phase-separated glasses” and “phase-separated glass ceramics,” as used herein, refers to glasses and glass ceramics that are separated into at least two compositionally different phases. For example, borosilicate glasses in certain composition regions tend to separate into a silica-rich phase, and a borate-rich phase upon heat treatment. In some borosilicate glass compositions, the silica-rich phase is continuous, while the borate-rich phase is either continuous at sufficiently high borate concentrations, or at low borate concentrations, the borate-rich phase may be incorporated in the form of colloids in the major silica-rich phase.

“Nanowires,” as used herein, refers to a nanostructure, with the diameter of the order of a nanometer (10⁻⁹ meters), or alternatively, can refer to structures that have a thickness or diameter constrained to tens of nanometers or less and an unconstrained length.

“Powders,” as used herein, refers to finely dispersed solid particles with an average diameter along their shortest dimension of from about 10 nm to about 500 μm.

The current disclosure expands the scope of applications available for the manufacturing of unique structures, such as nanowires, films, and powders. Many powders and nanowires are made of oxide materials such silica, titania and alumina. Manufacturing of nanostructured materials, such as powders and nanowires may be accomplished by a variety of techniques that use either gas or solutions as its precursors. The use of typical semiconductor techniques such as deposition/growth, oxidation, photolithography, dry etching and wet etching, allow the manufacturing of some semiconductor nanowires and powders on substrates, such as silicon nanowires on top of a silicon wafer. However, all these methods have relative difficulty in producing large quantities of nanowires cheaply and none are capable of producing three dimensional structures comprising these substances.

Current embodiments disclose cheap, efficient and powerful ways to manufacture highly porous structures. In some cases, these structures comprise nanowires that can be used in photoluminescent devices, gas/bio sensors, catalytic activity and perhaps in future electronic devices. In some aspects, the structures comprise highly porous phase separated glasses or glass ceramics that may be used in photoluminescent devices, gas/bio sensors, catalytic activity, and perhaps in future electronic devices.

Aerogels, such as silica aerogels, are some of the lightest materials known. With the use of the metallothermal reduction it is possible to create the lightest three dimensional semiconductor arrangement or metallic arrangement known, and therefore by reduction (removal of oxygen from the aerogels), new, extremely light materials.

Traditionally, nanowires are formed using vacuum systems or very high temperatures, often along with toxic gases such as the ones used in CVD systems (silane, phosphine, etc.). Embodiments herein avoid many of these problems while allowing for production of large amounts of nanowires simultaneously.

In one embodiment, the composition comprises an aerometal. In some embodiments, the aerometal comprises a transition metal. In some embodiments, the aerometal comprises a metalloid. In some embodiments, the aerometal comprises a lanthanide- or actinide-series metal. In some embodiments, the aerometal comprises B, Si, Al, Sc, Ti, V, Cr, Mn, Fe, Co, Ni, Cu, Zn, Ga, Ge, As, Se, Y, Zr, Nb, Mo, Tc, Ru, Rh, Pd, Ag, Cd, In, Sn, Sb, Te, Lu, Hf, Ta, W, Re, Os, Ir, Pt, Au, Tl, Pb, Bi, Po, La, Ce, Pr, Nd, Pm, Sm, Eu, Gd, Tb, Dy, Ho, Er, Tm, Yb, Ac, Th, Pa, U, Np, Pu, Am, or Cm.

Aerometals have ultralow densities due to their formation from aerogel precursors. In some embodiments, the aerometal has a density of from about 1 mg/cm³ to about 500 mg/cm³. In some embodiments, the aerometal has a density of about 1, 2, 3, 4, 5, 6, 7, 8, 9, 10, 15, 20, 25, 30, 35, 40, 45, 50, 60, 70, 80, 90, 100, 125, 150, 175, 200, 225, 250, 275, 300, 350, 400, 450, or 500 mg/cm³.

Aerometals, in some embodiments, have high surface areas and/or are highly porous. In some embodiments, the aerometal has a surface area from about 200 to about 2000 m²/g. In some embodiments, the surface area is about 200, 225, 250, 275, 300, 325, 350, 375, 400, 425, 450, 475, 500, 525, 550, 575, 600, 625, 650, 675, 700, 725, 750, 775, 800, 825, 850, 875, 900, 1000, 1100, 1200, 1300, 1400, 1500, 1600, 1700, 1800, 1900, or 2000 m²/g. In some embodiments, the aerometal has an average pore size of from about 0.4 nm to about 1000 nm. In some embodiments, the average pore size is about 0.4, 0.5, 0.6, 0.7, 0.8, 0.9, 1.0, 1.5, 2.0, 2.5, 3.0, 3.5, 4.0, 5.0, 6.0, 7.0, 8.0, 9.0, 10, 15, 20, 25, 30, 35, 40, 45, 50, 60, 70, 80, 90, 100, 125, 150, 175, 200, 225, 250, 275, 300, 350, 400, 450, 500, 550, 600, 650, 700, 750, 800, 850, 900, 950, or 1000 nm.

In some embodiments, the aerometal is photoluminescent or electroluminescent. In some embodiments, the aerometal is photoluminescent of electroluminescent in the UV, visible, and/or IR regions of the electromagnetic spectrum. In some embodiments, the aerometal is photoluminescent of electroluminescent in the UV region. In some embodiments, the aerometal is photoluminescent or electroluminescent in the visible region.

One unexpected result of the formation of aerometals is the formation of nanowires. In forming aerometals from aerogels, the resulting aerometal may comprise nanowires of the metal or metalloid. Use of this process allows for the formation of large number of nanowires simultaneously. In some embodiments, the nanowires comprise a combination of one or more elemental types of nanowire. In some embodiments, the nanowires may be interwoven. In some embodiments, the nanowires may form a three dimensional structure, which may be porous.

Aerometals may further be formed, produced, or converted to powders subsequent to formation. The aerometal powders may comprise either porous or nonporous structures. In some embodiments, the aerometal powders comprise nanowires. The powders may have an average particle size of from about 0.01 μm to 500 μm. In some embodiments, the particles have an average particle size of about 0.01, 0.02, 0.03, 0.04, 0.05, 0.1, 0.2, 0.3, 0.4, 0.5, 0.6, 0.7, 0.8, 0.9, 1, 2, 3, 4, 5, 6, 7, 8, 9, 10, 15, 20, 25, 30, 40, 50, 60, 70, 80, 90, 100, 150, 200, 250, 300, 350, 400, 450, or 500 μm.

Aerometals may be formed into any forms that the base aerogel may be formed into. This includes films, bodies, molds, monoliths, or other forms.

In another aspect, the processes herein described can be further extended to phase separated glasses and glass ceramics with similar performance and properties. Phase separate glasses are usually, but not necessarily, binary or ternary structures involving SiO₂, B₂O₃ and GeO₂. These oxides show strong tendency to phase separate. (See, e.g., Arun K. VArshneya, FUNDAMENTALS OF INORGANIC GLASSES, Chpt. 3, Academic Press (1994), herein incorporated by reference). One example is VYCOR® (Corning Inc.) that is Na₂O-B₂O₃-SiO₂ in the range 55-75% SiO₂, 20-35% B₂O₃ and 5-10% Na₂O. Other common phase separated systems are the BaO-B₂O₃-SiO₂ glasses. It is important that you can have a phase separated glass where the silicate and sodium borate phase are separated after a heat treatment process (for example, around 500-600° C. in VYCOR®). In order to make ‘porous VYCOR®’ it is necessary to etch the glass. The etching may be done in 3N H₂SO₄ at 90° C., which etches the sodium borate phase leading to a nanoporous mostly silica porous VYCOR®.

Glass ceramics are polycrystalline materials formed by the controlled crystallization of glasses. Glass ceramics can provide significant advantages over conventional glass or ceramic materials, by combining the ease and flexibility of forming glass with unique properties. Examples of glass ceramics that may be used in embodiments may be found in KIRK-OTHMER ENCYCLOPEDIA OF CHEMICAL TECHNOLOGY, Vol. 12., pp. 577-579 and 626-631, Wiley Interscience (5^{th} Ed. 2004), herein incorporated by reference.

One advantage to the use of phase separated glasses and glass ceramics is that they can be molded by extrusion or other techniques in multiple dimensions. In some embodiments, phase separated glasses and glass ceramic comprise silicate, borosilicate (e.g., VYCOR®, PYREX®). In some embodiments, phase separated glasses and glass ceramics may have an average pore size from about 0.4 to 1000 nm. In some embodiments, the metal or metalloid body formed from the phase separated glass or glass ceramic have an average pore size from about 0.4 to 1000 nm. In some embodiments the average pore size of the phase separated glass or glass ceramic and/or the body formed therefrom is about 0.4, 0.5, 0.6, 0.7, 0.8, 0.9, 1.0, 1.5, 2.0, 2.5, 3.0, 3.5, 4.0, 5.0, 6.0, 7.0, 8.0, 9.0, 10, 15, 20, 25, 30, 35, 40, 45, 50, 60, 70, 80, 90, 100, 125, 150, 175, 200, 225, 250, 275, 300, 350, 400, 450, 500, 550, 600, 650, 700, 750, 800, 850, 900, 950, or 1000 nm. Additionally, in some embodiments, the surface area of the body formed from the phase separated glass or glass ceramic comprises from about 200 to about 2000 m²/g. In some embodiments, the surface area is about 200, 225, 250, 275, 300, 325, 350, 375, 400, 425, 450, 475, 500, 525, 550, 575, 600, 625, 650, 675, 700, 725, 750, 775, 800, 825, 850, 875, 900, 1000, 1100, 1200, 1300, 1400, 1500, 1600, 1700, 1800, 1900, or 2000 m²/g.

The body formed from the phase separated glass or glass ceramic may further be formed, produced, or converted to powders subsequent to formation. The powders may comprise either porous or nonporous structures. In some embodiments the powders are porous. The powders may have an average particle size of from about 0.01 μm to 500 μm. In some embodiments, the particles have an average particle size of about 0.01, 0.02, 0.03, 0.04, 0.05, 0.1, 0.2, 0.3, 0.4, 0.5, 0.6, 0.7, 0.8, 0.9, 1, 2, 3, 4, 5, 6, 7, 8, 9, 10, 15, 20, 25, 30, 40, 50, 60, 70, 80, 90, 100, 150, 200, 250, 300, 350, 400, 450, or 500 μm.

Additionally, the body formed from the phase separated glass or glass ceramic may be formed into any forms that the base material be formed into. This includes extruded bodies, films, bodies, molds, monoliths, or other forms.

In another aspect, embodiments may be produced by the method comprising forming an aerogel of a metal oxide or metallaloid oxide and subjecting the aerogel to a metallothermic process, or alternatively, forming a phase separated glass or glass ceramic and subjecting it to a metallothermic process. In some embodiments, the method comprises providing an aerogel or a phase separated glass or glass ceramic comprising a metal oxide or metalloid oxide and extracting oxygen from the aerogel or a phase separated glass or glass ceramic by reacting a metallic gas with the substrate in a heated inert atmosphere to form a metal-oxygen complex, wherein the inert atmosphere is heated to a reaction temperature sufficient to facilitate the oxygen extraction. In some embodiments, the formed metal-oxygen complex is removed to yield a nanostructured substrate with a density of less than 500 mg/cm³. In some embodiments, the formed material has a density of about 1, 2, 3, 4, 5, 6, 7, 8, 9, 10, 15, 20, 25, 30, 35, 40, 45, 50, 60, 70, 80, 90, 100, 125, 150, 175, 200, 225, 250, 275, 300, 350, 400, 450, or 500 mg/cm³.

As an example of one embodied process comprises the reaction of a general metal or metalloid oxide substrate and metallothermic reduction via Mg gas. However, as noted previously, the scope of the present disclosure extends beyond specific metallothermic reduction processes. More specifically, according to embodiments described herein, an metal- or metalloid-based structure comprising a porous metal or metalloid layer can be fabricated by extracting oxygen from the atomic elemental composition of a metal or metalloid oxide. The metal or metalloid oxide substrate may comprise any metal or metalloid element, such as, but not limited to, silicon, aluminum, iron, copper, boron, or combinations thereof. Oxygen is extracted from the metal or metalloid oxide substrate by reacting a metallic gas, such as Mg, with the metal or metalloid oxide substrate in a heated inert atmosphere to form a metal-oxygen complex along a surface of the metal or metalloid oxide substrate.

To facilitate the oxygen extraction, the inert atmosphere is heated to a reaction temperature T, which, in the case of many metal or metalloid oxide substrates, will be between about 400° C. and about 900° C. For example, and not by way of limitation, for alkaline earth alumina borosilicate glass, a suitable reaction temperature T will be approximately 675° C. or slightly less and can be maintained for approximately two hours. In some embodiments, the reaction temperature is about 400° C., 425° C., 450° C., 475° C., 500° C., 525° C., 550° C., 575° C., 600° C., 625° C., 650° C., 675° C., 700° C., 725° C., 750° C., 775° C., 800° C., 825° C., 850° C., 875° C., or 900° C. In most cases, the metal or metalloid oxide substrate can be characterized by a thermal strain point and the inert atmosphere can be heated to a reaction temperature below the thermal strain point of the metal or metalloid oxide substrate. For example, and not by way of limitation, for glass having a strain point of about 669° C., the inert atmosphere can be heated to about 660° C. Reduced reaction temperatures are contemplated for low pressure reaction chambers.

The metal or metalloid oxide substrate may comprise any form. In some embodiments the metal or metalloid oxide substrate is an aerogel or a phase separated glass or glass ceramic. In some embodiments, the aerogel or phase separated glass or glass ceramic comprises oxides of boron, phosphorous, titanium, germanium, zirconium, vanadium, etc.

It is contemplated that a variety of suitable reduction gases can be utilized without departing from the scope of the present disclosure. For example, and not by way of limitation, it is contemplated that the metallic reducing gas may comprise Mg, Ca, Na, Rb, or combinations thereof. In a simplified, somewhat ideal case, where the metallic gas comprises Mg, the corresponding stoichiometric reaction with the silica glass substrate is as follows:

2Mg+SiO₂→Si+2MgO.

Analogous reactions would characteristic for similar reducing gases.

In non-stoichiometric or more complex cases, reaction byproducts like Mg₂Si are generated and the reducing step described above can be followed by the byproduct removal steps described herein. To avoid byproduct generation and the need for the byproduct removal step, it is contemplated that the stoichiometry of the reduction can be tailored such that the metallic gas is provided in an amount that is not sufficient to generate the byproduct. However, in many cases, the composition of the glass will be such that the generation of additional reaction byproducts is inevitable, in which case these additional byproducts can be removed by the etching and thermal byproduct removal steps described herein.

To enhance reduction, the metal or metalloid substrate can be subject to microwave or RF exposure while reacting the metallic gas with the metal or metalloid substrate. The metallic gas can be derived from any conventional or yet to be developed source including, for example, a metal source subject to microwave, plasma or laser sublimation, an electrical current, or a plasma arc to induce metal gas formation. In cases where the metallic gas is derived from a metal source, it is contemplated that the composition of the metal source can be varied while reacting the metallic gas with the metal or metalloid substrate to further enhance reduction.

Additional defects can be formed in the metal or metalloid substrate by irradiating the surface of the substrate with electrons. The resulting defects enable a more facile and extensive extraction of oxygen by the metallothermic reducing gas agent and, as such, can be used to enhance oxygen extraction by subjecting the glass substrate to electron beam irradiation prior to the above-described metallothermic reduction processes. Contemplated dosages include, but are not limited to, dosages from approximately 10 kGy to approximately 75 kGy, with acceleration voltages of approximately 125 KV. Higher dosages and acceleration voltages are contemplated and deemed likely to be advantageous.

The metal-oxygen complex that is formed may be removed to yield a porous metal or metalloid structure. Although the various embodiments of the present disclosure are not limited to a particular removal process, it is noted that the metal-oxygen complex can be removed from the surface of the metal or metalloid substrate by executing a post-reaction acid etching step. For example, and not by way of limitation, post-reaction acid etching may be executed in 1M HCl solution (molar HCl:H₂O:EtOH ratio=0.66:4.72:8.88) for at least 2 hours. Depending on the porosity of the glass, some additional MgO may be trapped inside the glass and additional etching may be needed for longer periods of time with multiple flushes of the acidic mixture.

In embodiments, the disclosure provides a composition comprising an aerometal. In some embodiments, aerometal has a density of from about 1 mg/cm³ to about 500 mg/cm³. In some embodiments, the aerometal has a surface area of from about 200 to about 2000 m²/g. In some embodiments, the aerometal has an average pore size of from about 0.4 to 1000 nm. In some embodiments, aerometal is photoluminescent or electroluminescent. In some embodiments, the aerometal comprises a nanowire, a powder, a film, or a three-dimensional body.

In embodiments, the disclosure provides a method of producing an aerometal, comprising:
a. forming an aerogel of a metal oxide or metallaloid oxide;
b. subjecting the aerogel to a metallothermic process; and
c. optionally, removing reaction by-products to give a substantially pure aerometal.

In some embodiments of the method, the subjecting the aerogel to a metallothermic process comprises heating to a temperature of greater than 400° C. for more than 2 hours or subjecting the aerogel to a metallothermic process comprises heating to a temperature of greater than 400° C. for more than 2 hours and subsequently, heating to a temperature of greater than 600° C. for more than 2 hours. In some embodiments, the removing reaction by-products comprises acid etching the aerometal. In some embodiments, the aerometal produced has a density of from about 1 mg/cm³ to about 500 mg/cm³. In some embodiments, the aerometal has an average pore size of from about 0.4 to 1000 nm. In some embodiments, aerometal is photoluminescent or electroluminescent. In some embodiments, the aerometal comprises a nanowire, a powder, a film, or a three-dimensional body.

In embodiments, the disclosure provides a method of forming an aerometal comprising:
a. providing an aerogel comprising a metal oxide or metalloid oxide;
b. extracting oxygen from the aerogel by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield a nanostructured substrate with a density of less than 500 mg/cm³.

In embodiments, the disclosure provides a composition comprising an elemental nanowire, a body, a film, or a powder, wherein the composition has a density from about 1 mg/cm³ to about 500 mg/cm³ and the elemental nanowire, a body, a film, or a powder comprises a metal or metalloid. In some embodiments, the composition comprises an elemental nanowire. In some embodiments, the composition comprises a three dimensional body. In some embodiments, the composition comprises a film. In some embodiments, the composition comprises a powder. In some embodiments, the composition comprises nanoparticles. In some embodiments, the composition comprises an aerometal. In some embodiments, the composition has a density of from about 1 mg/cm³ to about 500 mg/cm³. In some embodiments, the composition has a surface area of from about 200 to about 2000 m²/g. In some embodiments, the composition has an average pore size of from about 0.4 to 1000 nm. In some embodiments, the composition is photoluminescent or electroluminescent. In some embodiments, the composition comprises a powder, a film, or a three-dimensional body.

In embodiments, the disclosure provides a method of producing a nanowire comprising:
a. forming an aerogel of a metal oxide or metallaloid oxide;
b. subjecting the aerogel to a metallothermic process to form metal or metalloid nanowires;
c. optionally, removing reaction by-products to give a substantially pure nanowires; and
d. optionally, isolating the substantially pure nanowires.

In some embodiments, the subjecting the aerogel to a metallothermic process comprises heating to a temperature of greater than 400° C. for more than 2 hours. In some embodiments, the subjecting the aerogel to a metallothermic process comprises heating to a temperature of greater than 400° C. for more than 2 hours and subsequently, heating to a temperature of greater than 600° C. for more than 2 hours. In some embodiments, the removing reaction by-products comprises acid etching the nanowires. In some embodiments, the nanowire comprises a powder, a film, or a three-dimensional body.

In embodiments, the disclosure provides a method of forming a nanowire comprising:
a. providing an aerogel comprising a metal oxide or metalloid oxide;
b. extracting oxygen from the aerogel by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield a nanostructured substrate with a density of less than 500 mg/cm³.

In embodiments, the disclosure provides a body comprising a cellular structure wherein the body comprises a metal or metalloid in elemental form; wherein the cellular structure comprises interconnected pores with an average pore size of from about 0.4 to 1000 nm. In some embodiments, the surface area of the body is from about 200 to 2000 m²/g. In some embodiments, the body is photoluminescent or electroluminescent. In some embodiments, the body is photoluminescent below 400 nm. In some embodiments, the body is formed from a phase separated glass or glass ceramic. In some embodiments, the phase separated glass or glass ceramic comprises a borosilicate glass. In some embodiments, the disclosure provides an article comprising the body.

In embodiments, the disclosure provides a film comprising a cellular structure wherein the film comprises a metal or metalloid in elemental form; wherein the cellular structure comprises interconnected pores with an average pore size of from about 0.4 to 1000 nm. In some embodiments, the surface area of the film is from about 200 to 2000 m²/g. In some embodiments, the film is photoluminescent or electroluminescent. In some embodiments, the film is photoluminescent below 400 nm. In some embodiments, the film is formed from a phase separated glass or glass ceramic. In some embodiments, the phase separated glass or glass ceramic comprises a borosilicate glass. In some embodiments, the disclosure provides an article comprising the film.

In embodiments, the disclosure provides a powder comprising a cellular structure wherein the powder comprises a metal or metalloid in elemental form; wherein the cellular structure comprises interconnected pores with an average pore size of from about 0.4 to 1000 nm. In some embodiments, the surface area of the powder is from about 200 to 2000 m²/g. In some embodiments, the powder is photoluminescent or electroluminescent. In some embodiments, the powder is photoluminescent below 400 nm. In some embodiments, the powder is formed from a phase separated glass or glass ceramic. In some embodiments, the phase separated glass or glass ceramic comprises a borosilicate glass. In some embodiments, the disclosure provides an article comprising the powder.

In embodiments, the disclosure provides a method of forming a body comprising a cellular structure wherein the body comprises a metal or metalloid in elemental form; wherein the cellular structure comprises interconnected pores with an average pore size of from about 0.4 to 1000 nm, comprising:
a. providing a phase separated glass or glass ceramic article;
b. extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield the body.

In some embodiments, the surface area of the body is from about 200 to 2000 m²/g. In some embodiments, the body is photoluminescent or electroluminescent. In some embodiments, the body is photoluminescent below 400 nm. In some embodiments, the body is formed from a phase separated glass or glass ceramic. In some embodiments, the phase separated glass or glass ceramic comprises a borosilicate glass. In some embodiments, the disclosure provides an article comprising the body.

In embodiments, the disclosure provides a method of forming a film comprising a cellular structure wherein the film comprises a metal or metalloid in elemental form; wherein the cellular structure comprises interconnected pores with an average pore size of from about 0.4 to 1000 nm, comprising:
a. providing a phase separated glass or glass ceramic article;
b. extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield the film.

In some embodiments, the surface area of the film is from about 200 to 2000 m²/g. In some embodiments, the film is photoluminescent or electroluminescent. In some embodiments, the film is photoluminescent below 400 nm. In some embodiments, the film is formed from a phase separated glass or glass ceramic. In some embodiments, the phase separated glass or glass ceramic comprises a borosilicate glass. In some embodiments, the disclosure provides an article comprising the film.

In embodiments, the disclosure provides a method of forming a powder comprising a cellular structure wherein the powder comprises a metal or metalloid in elemental form; wherein the cellular structure comprises interconnected pores with an average pore size of from about 0.4 to 1000 nm, comprising:
a. providing a phase separated glass or glass ceramic article;
b. extracting oxygen from the phase separated glass or glass ceramic article by reacting a metallic gas with the substrate in a heated inert atmosphere to form a metal-oxygen complex, wherein the inert atmosphere is heated to a reaction temperature sufficient to facilitate the oxygen extraction; and
c. removing the metal-oxygen complex to yield the powder.

In some embodiments, the surface area of the powder is from about 200 to 2000 m²/g. In some embodiments, the powder is photoluminescent or electroluminescent. In some embodiments, the powder is photoluminescent below 400 nm. In some embodiments, the powder is formed from a phase separated glass or glass ceramic. In some embodiments, the phase separated glass or glass ceramic comprises a borosilicate glass. In some embodiments, the disclosure provides an article comprising the powder.

### EXAMPLES

### Example 1

### Silica Aerometals from Silica Aeroels

Silica aerogels were purchased and used as obtained. The magnesium source used was magnesium turnings 99.8% pure from Alfa Aesar. The Mg turnings were put at the bottom of a graphite crucible with a lid made of a graphite plate. The aerogel was put into the crucible

The crucible was put into an oven under an Argon atmosphere at 650-675° C. (we used 660° C. to keep the temperature below the strain point of the glass and to avoid stress to the samples) for a period of 2 hours, and then cooled. The Mg gas reacts with silica to produce porous silicon (Si) (gray in color) and the MgO byproduct which appears as a brown color stain on the material's surface. A second by-product of this reaction is the appearance of Mg₂Si that arises from a secondary reaction of the formed Si with more Mg due to the non-balanced amount of Mg used in the reaction (more Mg than Si atoms).

Subsequently, the sample is heated again under a controlled inert atmosphere (here Argon) at a temperature higher than 650° C. (here we used 660° C.) with no Mg present. The Mg₂Si is evaporated leaving only Si and MgO.

As a final step, the sample is subjected to acid etching in 1M HCl solution (molar HCl:H₂O:EtoH ratio=0.66:4.72:8.88). The aerogel was put into a glass contained and etched anywhere from a few minutes to dozens hours, which allowed for full removal of the MgO. The final result was porous Si and potentially some residual silica in the powder form that can be further etched in HF if needed.

### Example 2

### Phase Separated Class-Based Compositions

The reaction process detailed in Example 1 was repeated using phase separated glass powder (Vycor®) and phase separated glass extruded forms (Vycor®). The pieces of glass were put into the crucible and the glass powder was put into a smaller crucible inside the first one together with some extra Mg turnings in a mix. For the final etching step, robust 3D structures were still observed after the etching process. Depending on the porosity of the glass some additional MgO may be trapped inside the glass and additional etching is needed for longer periods of time with multiple flushes of the acidic mixture.

### Example 3

### Characterization of Samples

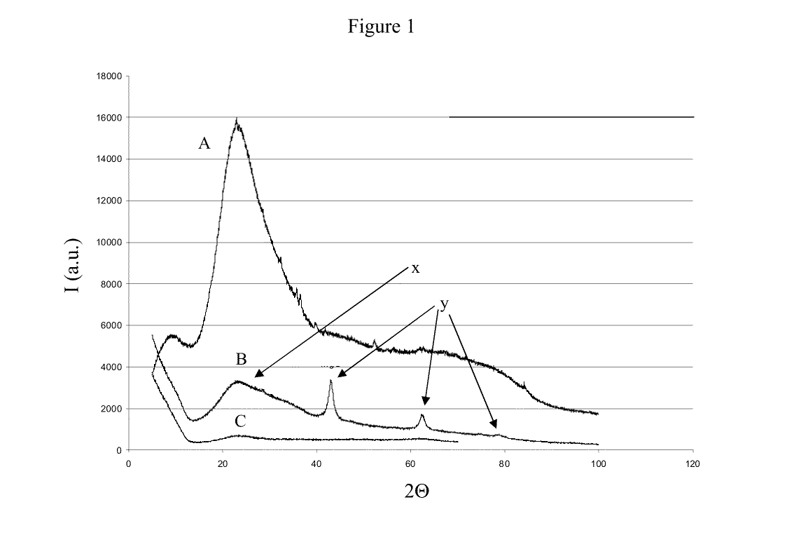

In FIG. 1, we show X-ray diffraction spectra of silica aerogel (spectrum “A”) showing its amorphous background and lack of crystallinity peaks, in comparison to aerosilicon (spectrum “B”). Spectrum B shows the aerosilicon after processing at (660° C. for 4 hours+725° C. for 6 hours). The graph shows the appearance of peaks for MgO and Si as consistent with this stage of the processing of the sample. After the etching step, shown in spectrum C, the aerogel sample collapsed due to the surface tension with the liquid and showed some strange peaks corresponding to Mg₂SiO₄.

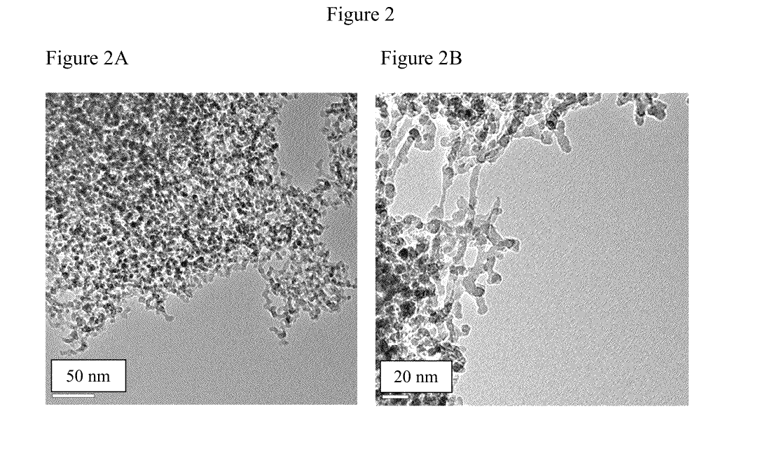

FIGS. 2A and 2B show TEM images of the sample after processing 660° C. for 4 hours and subsequently 725° C. for 6 hours. Here one can observe the nanowires that are a mixture of MgO and Si and SiO₂. Some of the nanowires are around a few nanometers in width (e.g. 4-5 nm) while being as long as several dozens of nanometers.

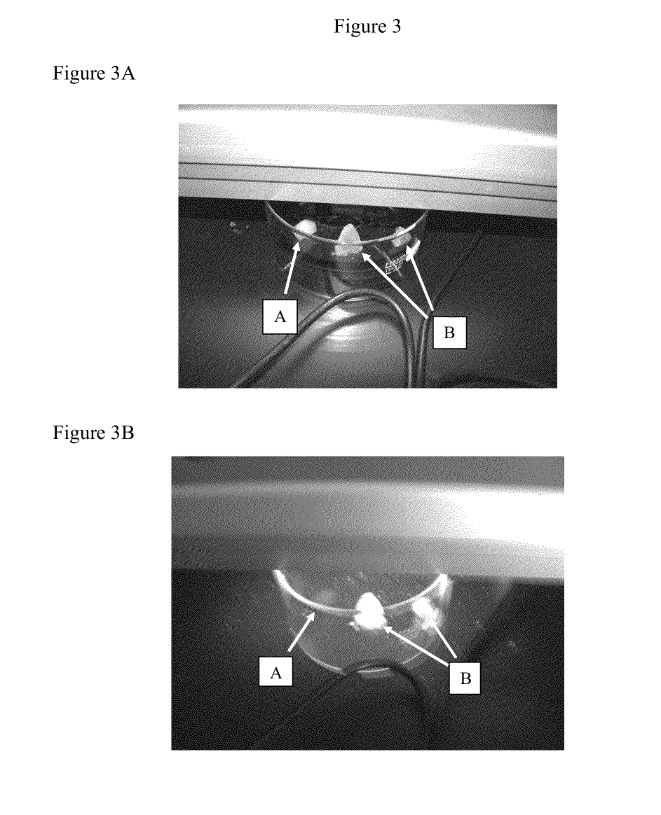

FIGS. 3A and 3B is a photograph of the optical emission of silica aerogel (object “A”) and the aerosilicon (objects “B”) under different light conditions. The aerosilicon was processed at 660° C. for 4 hours and subsequently 725° C. for 6 hours without the final acid etch. In ambient light (FIG. 3A), the aerogel is pristine and blue in haze, while the aerosilicon is of a gray color. Under a hand held UV lamp at 365 nm (FIG. 3B), the silica aerogel does not present photoluminescence, but the aerosilcon presented photoluminescence in the white/blue spectral range. The aerosilicon showed luminescence at 365 nm (strong intensity) and 302 nm (medium intensity).

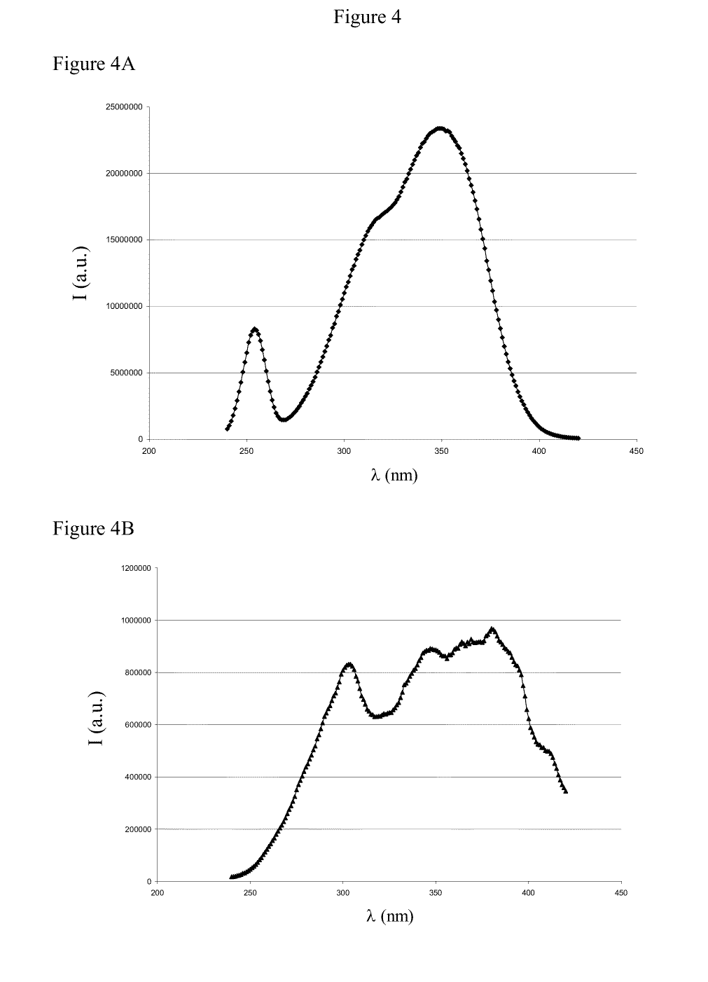

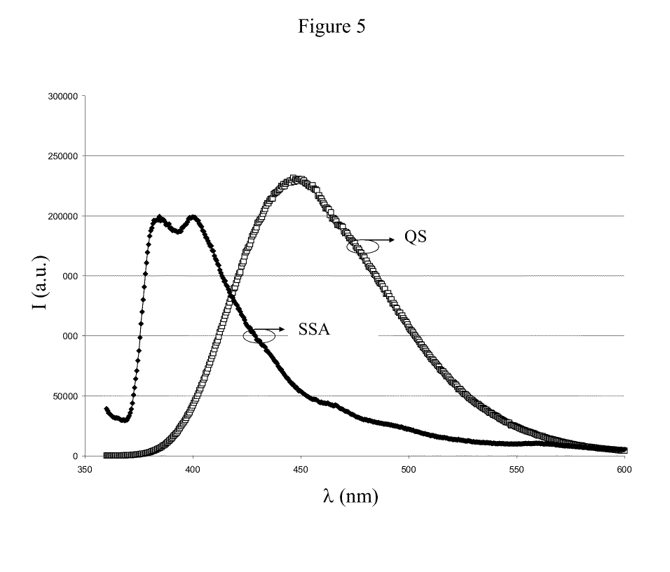

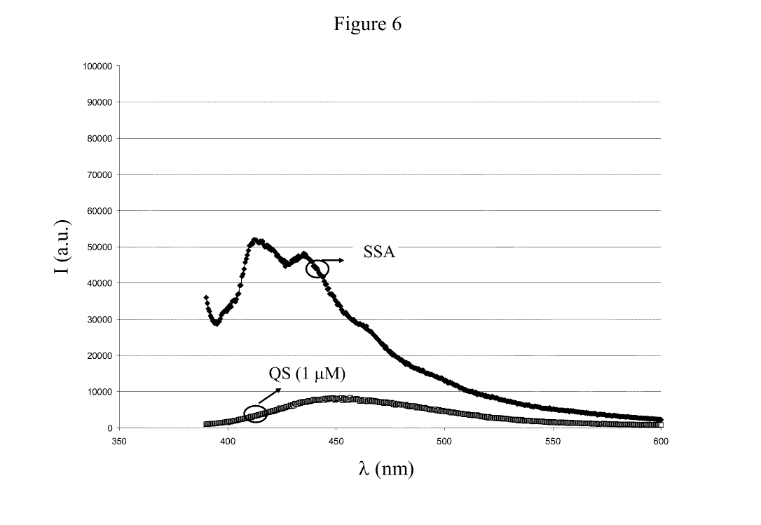

FIGS. 4A and 4B compare the excitation spectra of quinine sulfate at 1 μM concentration as a reference (target emission 447.5 nm) (FIG. 4A) versus aerosilicon, where the target emission is at 440 nm (FIG. 4B). FIGS. 5 and 6 describe the emission spectra of quinine sulfate (spectra “QS”) versus the aerosilicon (spectra “SSA”). In this case one can compare the emission obtained under these conditions for the aerosilicon and the quinine sulfate with a concentration of 10 μM in H₂SO₄ (FIGS. 5) and 10 μM in H₂SO₄ (FIG. 6).

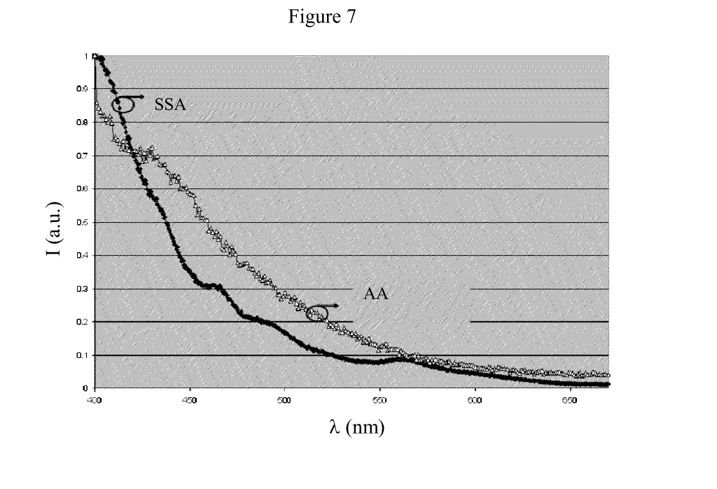

FIG. 7 compares aerosilicon (spectrum “SSA”) to aeroaluminum (spectrum “AA”). The aeroaluminum presented similar photoluminescence behavior as the silica aerogel. As shown in the figure, the spectral characteristics for aeroaluminum are red shifted, leading to a more warm emission with a white-orange luminescence.

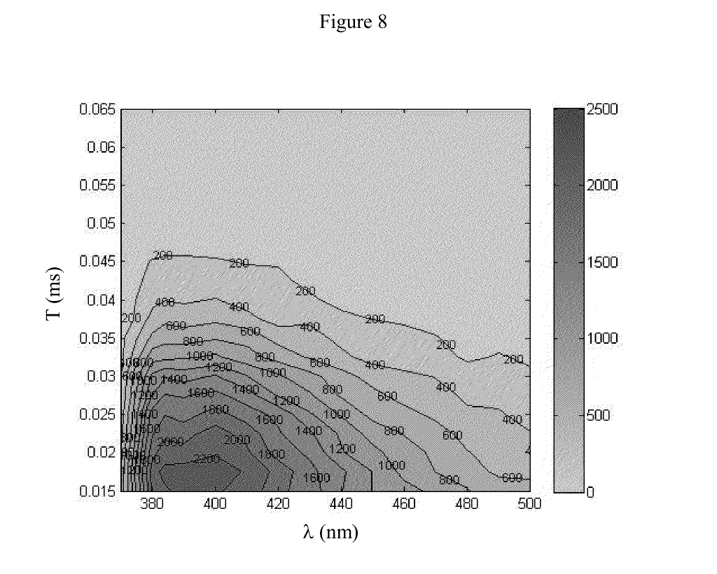

FIG. 8 is a contour graph of the lifetime measured form excitation at 349 nm with a bandwidth of 1 nm of the aerosilicon. The graph describes the lifetimes observed in a photomultiplier tube for a wavelength range from 380 nm to 600 nm with a bandwidth of 1 nm. An untreated silica aerogel was used as reference sample and its spectra due to scattering of light or possible impurity defects subtracted. One can observe the peak and different decays depending on the wavelength of emission.

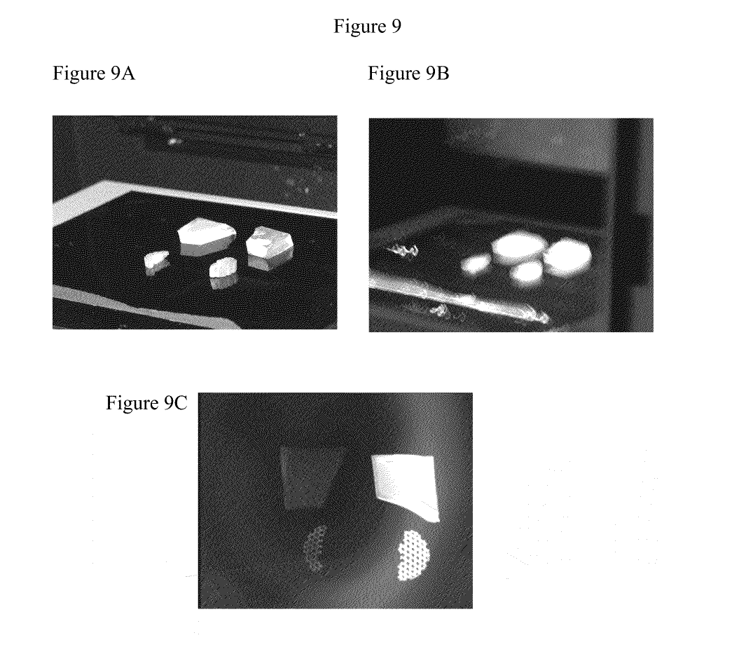

FIGS. 9A, 9B, and 9C are photographs of the optical emission of a porous Vycor® slab and from an extruded porous Vycor® 3D monolith both before and after methalothermic processing to form the silicon equivalent. The samples were processed at 660° C. for 4 hours, 725° C. for 6 hours, and then an acid etch in HCl:EtOH:H₂O solution. Under ambient light, the unprocessed and processed samples look similar (FIG. 9A), but when exposed to UV radiation, the processed sample was strongly luminescent in the UV at 365 nm (strong intensity) and 302 nm (medium intensity) (FIG. 9B). FIG. 9C compares the luminescence in the presence of a UV filter of the treated and untreated Vycor® samples. As can be seen from the figure, the processed Vycor® sample shows strong luminescence in the UV region.

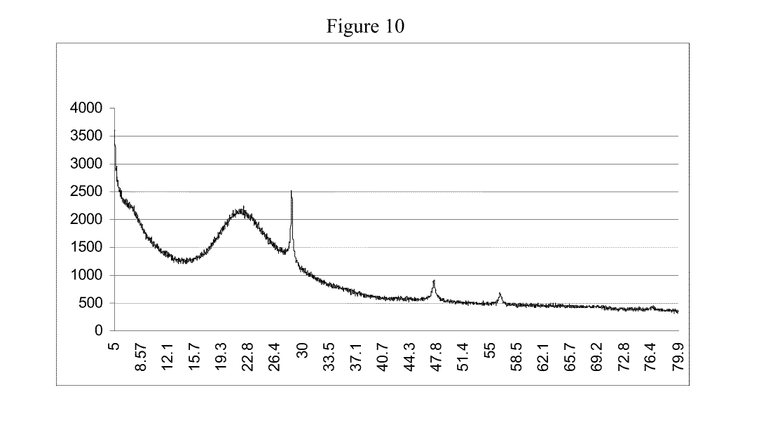

FIG. 10 is an X-ray diffraction spectrum of the extruded porous Vycor® in the form of a 3D monolith of silicon. As expected, it shows just the peaks related to silicon.

1. A composition comprising an aerometal.

2. The composition of claim 1, wherein the aerometal has a density of from about 1 mg/cm³ to about 500 mg/cm³.

3. The composition of claim 1, wherein the aerometal has a surface area of from about 200 to about 2000 m²/g.

4. The composition of claim 1, wherein the aerometal has an average pore size of from about 0.4 to 1000 nm.

5. The composition of claim 1, wherein the aerometal is photoluminescent or electroluminescent.

6. The composition of claim 1, wherein the aerometal comprises a nanowire, a powder, a film or a three-dimensional body.

7. A method of producing an aerometal, comprising:
a. forming an aerogel of a metal oxide or metallaloid oxide;
b. subjecting the aerogel to a metallothermic process; and
c. optionally, removing reaction by-products to give a substantially pure aerometal.

8. The method of claim 7, wherein the subjecting the aerogel to a metallothermic process comprises heating to a temperature of greater than 400° C. for more than 2 hours and subsequently, optionally heating to a temperature of greater than 600° C. for more than 2 hours.

9. The method of claim 7, wherein the removing reaction by-products comprises acid etching the aerometal.

10. The method of claim 7, wherein the aerometal produced has a density of from about 1 mg/cm³ to about 500 mg/cm³.

11. The method of claim 7, wherein the aerometal produced has an average pore size of from about 0.4 to 1000 nm.

12. The method of claim 7, wherein the aerometal produced is photoluminescent or electroluminescent.

13. The method of claim 7, wherein the aerometal produced comprises a nanowire, a powder, a film or a three-dimensional body.

14. A method of forming an aerometal comprising:
a) providing an aerogel comprising a metal oxide or metalloid oxide;
b) extracting oxygen from the aerogel by reacting a metallic gas with the substrate in a heated inert atmosphere to form a metal-oxygen complex, wherein the inert atmosphere is heated to a reaction temperature sufficient to facilitate the oxygen extraction; and
c) removing the metal-oxygen complex to yield a nanostructured substrate with a density of less than 500 mg/cm³.

15. An electrochemical device comprising the aerometal of claim 1.
